(19) United States
(12) Patent Application Publication
(10) Pub. No.: US 2024/0177015 A1
(43) Pub. Date: May 30, 2024

(54) OPTIMIZED REINFORCEMENT LEARNING FOR ARTIFICIAL INTELLIGENCE MODELS

(71) Applicant: SRI International, Menlo Park, CA (US)

(72) Inventor: Christopher Connolly, San Jose, CA (US)

(21) Appl. No.: 18/520,767

(22) Filed: Nov. 28, 2023

Related U.S. Application Data
(60) Provisional application No. 63/385,143, filed on Nov. 28, 2022.

(51) Int. Cl. G06N 3/092

(52) U.S. Cl. CPC G06N 3/092

(57) ABSTRACT

In an example, a system includes processing circuitry in communication with storage media, the processing circuitry configured to execute a reinforcement learning system configured to: perform, by an agent, an action within an environment; obtain one or more measurements from the environment, the one or more measurements resultant of the action performed by the agent; determine, based on the one or more measurements, a state of a domain model for the environment reached by the agent; and distribute credit, based at least in part on a reward associated with the state, across an explored state space for the domain model for the environment.

This application claims the benefit of U.S. patent application Ser. No. 63/385, 143, filed Nov. 28, 2022, which is incorporated by reference herein in its entirety.

### TECHNICAL FIELD

This disclosure is related to machine learning systems, and more specifically to optimized reinforcement learning for artificial intelligence models.

### BACKGROUND

Current Artificial Intelligence (AI) models that implement Reinforcement Learning (RL) typically estimate the expected value of reward at a certain state. Such estimation is called the value function. The value function is used to compute an optimal policy, which is a set of actions that maximize the expected reward. Current RL models use an exponential discount to craft the value function. In other words, the value of a reward decreases exponentially as the time horizon increases. The exponential discount is used to account for the fact that rewards that are further in the future are less likely to be received. However, current RL models require large numbers of samples to get a good estimate of the value function, because the value function is a function of all possible states and actions, and it may be difficult to sample from all of these possibilities.

Temporal differencing is a method of estimating the value function based on the observed reward values. The value function is a function that maps from states to their expected rewards. Temporal differencing works by updating the value function estimate after each time step, based on the reward that was received in the previous time step. The problem with temporal differencing is that it can only be used to estimate the value function for states that have been explored (or “visited”). This problem exists because temporal differencing relies on the observed reward values, and there are no observed reward values for states that have not been explored.

### SUMMARY

The disclosure describes techniques that involve estimating the value function for unvisited states by exploiting the connections between potential theory and probability theory. Potential theory deals with the study of potentials, which are functions that satisfy certain conditions. Probability theory deals with the study of probability, which is the likelihood of an event occurring. The value function may be considered a potential function because the value function maps from states to their expected rewards, and potentials similarly map from points to their values as determined by the functions.

The connections between potential theory and probability theory may be used to show that the value function may be solved as a Laplace's or Poisson's equation. Laplace's equation is a partial differential equation that describes the behavior of a classical electrical potential. Poisson's equation is a generalization of Laplace's equation that may also be used to describe the behavior of other types of potentials. By solving Laplace's or Poisson's equation for the value function, the problem of estimating the value function for unvisited states may be reduced to the computation of a classical electrical potential. The computation of a classical electrical potential may be done using a variety of methods, such as but not limited to, finite difference methods, finite element methods, and boundary element methods. The disclosed techniques have been shown to be effective in a variety of applications, such as—but not limited to—robotics. The disclosed techniques include a novel method for estimating the value function for unvisited states, which may improve the performance of RL systems.

The techniques described in the disclosure rely on two key ideas: incremental model construction and the assignment of value only at the boundary (reward states) as opposed to the whole state space. Incremental model construction means that the disclosed RL model is built up gradually, one state at a time. Such incremental model construction is in contrast to current RL models, which typically build a model of the entire state space before they start learning. The assignment of value only at the boundary (reward states) means that the value function is only assigned values for states that are on the boundary of the state space. In contrast, current RL models typically assign values to all states in the state space.

The techniques may provide one or more technical advantages over current methods of estimating the value function for unvisited states that realize at least one practical application. For example, the disclosed techniques may be more efficient, as they only require the solution of a single equation. As another example, the disclosed techniques may be more accurate, for the techniques can account for relationships among all of the states in the system. As another example, the disclosed techniques may be more flexible, for the techniques may be used to solve a variety of problems in a variety of contexts.

In an example, a system includes processing circuitry in communication with storage media, the processing circuitry configured to execute a reinforcement machine learning system configured to: perform a first action within an environment; obtain one or more measurements from the environment, the one or more measurements resultant of the first action; determine, based on the one or more measurements, a state of a domain model for the environment reached by the agent; and distribute credit, based at least in part on a reward associated with the state, across an explored state space for the domain model for the environment.

In an example, a method includes performing a first action within an environment; obtaining, by a reinforcement learning system, one or more measurements from the environment, the one or more measurements resultant of the action performed by the agent; determining, by the reinforcement learning system, based on the one or more measurements, a state of a domain model for the environment reached by the agent; and distributing credit, by the reinforcement learning system, based at least in part on a reward associated with the state, across an explored state space for the domain model for the environment.

In an example, non-transitory computer-readable storage media having instructions encoded thereon, the instructions configured to cause processing circuitry to: perform, by an agent, an action within an environment; obtain one or more measurements from the environment, the one or more measurements resultant of the action performed by the agent; determine, based on the one or more measurements, a state of a domain model for the environment reached by the agent; and distribute credit, based at least in part on a reward associated with the state, across an explored state space for the domain model for the environment.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 schematically shows a process in which a single agent interacts with an environment in a reinforcement learning system in accordance with the techniques of the disclosure.

FIG. 2 illustrates an example reinforcement learning system for training an agent to interact with an environment in accordance with the techniques of the disclosure.

FIG. 3 is a block diagram illustrating an example optimized reinforcement learning system in accordance with the techniques of the disclosure.

FIGS. 4A and 4B are graphs depicting world transitions as learned via different versions of RL agents in accordance with the techniques of the disclosure.

FIGS. 5A-5C are graphs depicting different measurements for different versions of RL agents (e.g., temporal differencing—TD agents—and Dirichlet differencing—DD agents in these examples) exploring different two-dimensional world graphs in accordance with the techniques of the disclosure.

FIG. 6 is a flowchart illustrating an example mode of operation for a machine learning system, according to techniques described in this disclosure.

Like reference characters refer to like elements throughout the figures and description.

### DETAILED DESCRIPTION

Neuroscience findings include: i) evidence of kinematic transformations in the cortico-striatal pathway; ii) evidence of segregated circuits that pass through distinct, well-defined territories in striatum; iii) evidence of Markovian action selection in reward-related learning in mice; iv) ample evidence of dopamine as a) a reward prediction error (RPE) signal, and b) a cue saliency signal; v) evidence of electrical connection among populations of striatal neurons. For example, evidence of kinematic transformations in the cortico-striatal pathway suggests that the cortico-striatal pathway is involved in the transformation of sensory information into motor commands.

The notion of the striatum as a kind of “prediction engine” is based on the idea that the striatum is involved in predicting the future rewards of actions. This prediction is based on an animal's past experiences. The dopamine signal is thought to be involved in updating these predictions. The hitting probabilities of a Markov chain are the probabilities of reaching a particular state from any other state in the chain. In other words, they are the probabilities of transitioning from one state to another.

An absorbing Markov chain is a Markov chain in which there is a set of absorbing states, and once a state is entered, the entered state cannot be left. The hitting probabilities of an absorbing Markov chain are the probabilities of reaching an absorbing state from any other state in the chain.

One interpretation of hitting probabilities in absorbing Markov chains is that the hitting probability, h(s), is the probability of reward, if there is some reward offered to the agent at absorbing states where h(s)=1. In other words, if the agent is in state s, then the probability of receiving a reward before transitioning to a non-absorbing state is h(s). The term “optimal policy,” as used herein, refers to the policy that maximizes the expected reward.

In an aspect, one example system may model the behavior of robots in a maze. The example system may use two types of Markov chains: place-space Markov chains and action chains. Place-space Markov chains are defined over the place geometry of the maze. The place geometry may be discretized into states, and the transition probabilities between states may be determined by the topological connections between the states. Action chains may be defined over the pairs of adjacent states in the place-space.

According to various aspects of the techniques, two additional features of the system that models the behavior of robots in a maze may include, but are not limited to: a machine learning system for transforming state information across state spaces and a machine learning system for allowing the state changes of one Markov chain to alter another, and vice versa. The machine learning system for transforming state information across state spaces may allow the system to transfer information between different Markov chains. For example, the system could use this machine learning system to transfer information about the location of a robot from a place-space Markov chain to an action chain. The machine learning system for allowing the state changes of one Markov chain to alter another may allow the system to model the interactions between different agents (robots) in the maze.

In some instances, there may be a relationship between the system that models the behavior of mice in a maze and Markov decision processes (MDPs). MDPs are a type of Markov chain that is used to model decision-making problems. In an MDP, the agent may choose from a set of actions, and each action may lead to a probability distribution over states.

In this respect, traditional reinforcement learning is a type of machine learning that allows agents to learn how to behave in an environment by trial and error. The agent learns by receiving rewards for taking actions that lead to desired outcomes. The value function is a central concept in reinforcement learning. The value function a function that maps from states to the expected value of reward from that state.

For the purposes of the following description and accompanying drawings, a reinforcement learning problem is definable by specifying the characteristics of one or more agents and an environment. The methods and systems described herein are applicable to a wide range of reinforcement learning problems, including both continuous and discrete high-dimensional state and action spaces. However, an example of a specific problem, namely a robot navigation problem, is referred to frequently for illustrative purposes and by way of example only.

A software agent, referred to hereafter as an agent, is a computer program component that may make decisions based on a set of input signals and may perform actions based on these decisions. In some applications of reinforcement learning, each agent may be associated with an entity in a physical system. In a non-limiting example of managing a fleet of taxis in a city, an agent may be assigned to represent each individual taxi in the fleet. In other applications of reinforcement learning, an agent may not be associated with an entity in a physical system. For example, an agent may be assigned to a non-playable character (NPC) in a video game. In some examples in which an agent is associated with an entity in a physical system, the agent may send control signals to the entity. In some examples, an agent may be implemented in software or hardware that is part of an associated physical entity (for example, within an autonomous robot). In other examples, an agent may be implemented by a computer system that is remote from the physical entity.

An environment may be a virtual system with which agents interact, and a complete specification of an environment may be referred to as a task. In many practical examples of reinforcement learning, the environment may simulate a physical system, defined in terms of information deemed relevant to the specific problem being posed. In the example of managing a fleet of taxis in a city, the environment may be a simulated model of the city, defined in terms of information relevant to the problem of managing a fleet of taxis, including for example, at least some of: a detailed map of the city; the location of each taxi in the fleet; information representing variations in time of day, weather, and season; the mean income of households in different areas of the city; the opening times of shops, restaurants and bars; and information about traffic.

It is assumed herein that interactions between an agent and an environment occur at discrete time steps n=0, 1, 2, 3, . . . . The discrete time steps do not necessarily correspond to times separated by fixed intervals. At each time step, the agent may receive data corresponding to an observation of the environment and data corresponding to a reward. The data corresponding to an observation of the environment may also include data indicative of probable future states, and the sent data may be referred to as a state signal and the observation of the environment may be referred to as a state. The state perceived by the agent at time step n is labelled Sₙ. The state observed by the agent may depend on variables associated with the agent itself. For example, in the taxi fleet management problem, the state observed by an agent representing a taxi may depend on the location of the taxi.

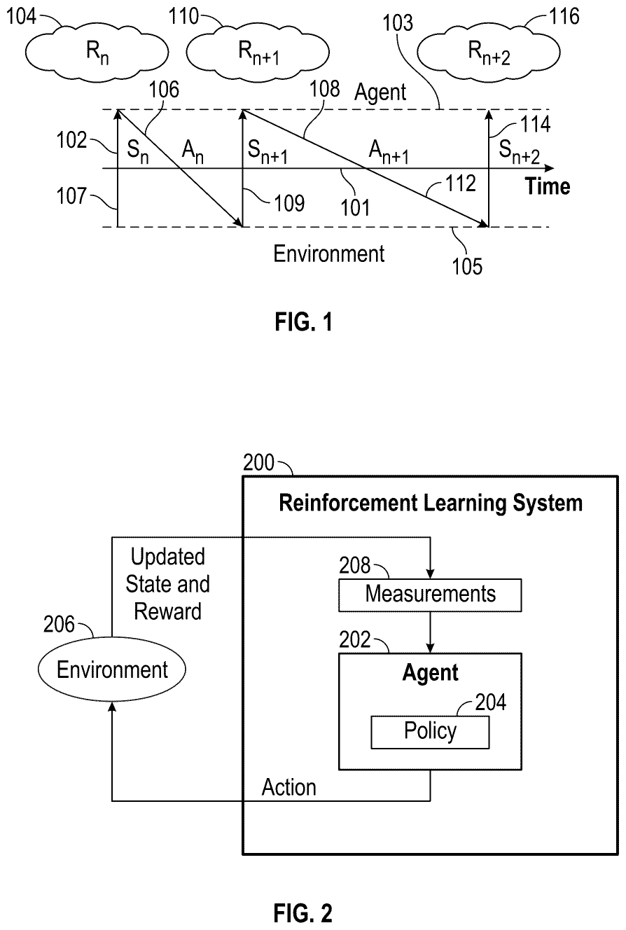

In response to receiving a state signal indicating a state Sₙ at a time step n, an agent may be able to select and perform an action Aₙ (as shown in FIG. 1 below) from a set of available actions in accordance with a MDP. In some examples, the true state of the environment may not be ascertained from the state signal, in which case the agent may select and performs the Action Aₙ in accordance with a Partially-Observable Markov Decision Process (PO-MDP). It should be noted that performing a selected action generally has an effect on the environment. In examples in which an agent is associated with an entity in a physical system, performing a selected action may correspond to sending a control signal to the entity. Data sent from an agent to the environment as an agent performs an action may be referred to as an action signal.

At a later time step n+1 (also shown in FIG. 1), the agent may receive a new state signal from the environment indicating a new state Sₙ₊₁. The new state signal may either be initiated by the agent completing the action Aₙ, or in response to a change in the environment. In examples in which the agent is associated with an entity in a physical system, the state signal may include data received from sensors in the physical system. In the example of managing a fleet of taxis, an agent representing a particular taxi may receive a state signal indicating that the taxi has just dropped a passenger at a point A in the city. Examples of available actions may include: to wait for passengers at A; to drive to a different point B; and to drive continuously around a closed loop C of the map. Depending on the configuration of the agents and the environment, the set of states, as well as the set of actions available in each state, may be finite or infinite. The methods and systems described herein are applicable in any of these cases.

FIG. 1 illustrates an example of a single agent interacting with an environment. The horizontal axis 101 represents increasing time, the dashed line 103 above the axis 101 represents the agent, and the dashed line 105 below the axis 101 represents the environment. At time step n, the agent 103 may receive a first state signal 107 from the environment 105, indicating a state Sₙ 102, and the agent 103 may receive an associated reward Rₙ 104 associated with the state Sₙ 102. In response to receiving the first state signal 107, the agent may 103 select an action Aₙ (e.g., first action) 106 in accordance with a policy π, and may perform the action Aₙ 106. The action Aₙ 106 may have an effect on the environment 105, and may be completed at time step n+1. Immediately after the action Aₙ 106 has been performed, the environment 105 may send a new state signal 109 to the agent 103, indicating a new state Sₙ₊₁ 108. The new state Sₙ₊₁ 108 may be associated with a reward Rₙ₊₋110. The agent 103 may then perform an action Aₙ₊(e.g., second action) 112, leading to a state Sₙ₊₂ 114 associated with a reward Rₙ₊₂ 116. As shown in FIG. 1, the interval between time steps n+1 and n+2 does not need to be the same as the interval between time steps n and n+1, and the reward Rₙ₊₂ 116 does not need to be the same as the rewards Rₙ₊₁ 110 or Rₙ 104.

A range of reinforcement learning algorithms are well-known, and different algorithms may be suitable depending on characteristics of the environment and the agents that define a reinforcement learning problem. Examples of reinforcement learning algorithms include, but are not limited to, dynamic programming methods, Monte Carlo methods, and temporal difference learning methods, including actor-critic methods. The present disclosure introduces systems and methods that facilitate the implementation of both existing and future reinforcement learning algorithms in cases of problems involving large or infinite numbers of states, and/or having multiple agents, that would otherwise be intractable using existing computing hardware.

FIG. 2 illustrates an example of a reinforcement learning system. The reinforcement learning system 200 may include an agent 202 (shown as agent 103 in FIG. 1) that determines actions based on a policy 204. Each time an action is determined, it is output to an environment 206 (shown as 105 in FIG. 1) being controlled by the agent 202. The action may update a state of the environment 206. The updated state may be returned to the reinforcement learning system 200 along with an associated reward for the action. The received information may used by the reinforcement learning system 200 to determine the next action. In general, the reward may be a numerical value. The reward may be based on any event or aspect of the environment 206. For example, the reward may indicate whether the agent 202 has accomplished a task (e.g., navigating to a target location in the environment 206) or the progress of the agent 202 towards accomplishing a task.

The interaction of the agent 202 with the environment 206 over one or more time steps may be represented by a “trajectory” (i.e., sequence) of measurements 208, which may be experience tuples (collectively referred to as experiences), where each experience tuple may correspond to a respective time step. An experience tuple corresponding to a time step may include: (i) an observation characterizing the state of the environment 206 at the time step, (ii) an action that was selected to be performed by the agent 202 at the time step, (iii) a subsequent observation characterizing a subsequent state of the environment subsequent to the agent 202 performing the selected action, (iv) a reward received subsequent to the agent 202 performing the selected action, and (v) a subsequent action that was selected to be performed at the subsequent time step.

The policy 204 may define how the system performs actions based on the state of the environment 206. As the system 200 is trained based on a set of measurements 208, the policy 204 followed by the agent 202 may be updated by assessing the value of actions according to an approximate value function, or return function to improve the expected return from the actions taken by the policy 204. This is typically achieved by a combination of prediction and control to assess the success of the actions performed by the agent 202, sometimes referred to as the “return”. The return may be calculated based on the rewards received following a given action. For instance, the return might be an accumulation of multiple reward values over multiple time steps.

In an aspect, the state space, action space, transition function, and reward function may be derived from a domain model. A domain model is a representation of the knowledge about a particular domain. The domain model may be represented in a variety of ways, such as, but not limited to a set of rules, a graph, or a machine learning framework such as a neural network. The state space may be the set of all possible states that the reinforcement learning system 200 can be in. As the reinforcement learning system 200 explores (visits) the state space, it may learn about the relationships between the different states, referred to herein as explored state space.

The agent 202 may perform a first action within the environment 206. This action can be anything, such as moving to a new location, taking a measurement, or interacting with an object. Next, the reinforcement learning system 200 may obtain one or more measurements from the environment 206. These measurements 208 (collectively referred to as “experiences”) may be used to update the topology of the explored state space. Next, the reinforcement learning system 200 may update the topology of the explored state space of a domain model for the environment based at least in part on the one or more measurements. For example, if a robot is exploring a new environment, it may use its sensors to collect measurements of its surroundings. These measurements may be used to create a state space that represents all of the possible configurations of the robot and its environment. As the robot explores, the robot may collect new measurements and use them to update the state space. The update may involve adding new states to the state space, removing states that are no longer possible, or updating the weights of connections between states. The topology of the explored state space may be a representation of the relationships between different states of the domain model. The measurements may be used to update the values associated with each of the states in the topology. In an aspect, the reinforcement learning system 200 may select, based at least in part on the updated topology, a second action to be performed by the agent 202 within the environment 206. The second action may be chosen in a way that is likely to maximize the reward that the reinforcement learning system 200 receives, as described below. In an aspect, the second action may be chosen based on the policy 204. Next, the agent 202 may perform the second action within the environment 206. As shown in FIG. 2, the process may be repeated, with the reinforcement learning system 200 continuously updating its knowledge of the environment 206 and selecting actions in a way that maximizes its reward.

In other words, when the agent 202 performs a number of actions within the environment 206, the reinforcement learning system 200 may be exploring the state space of the domain model. The state space may be the set of all possible states that the reinforcement learning system 200 can be in. As the reinforcement learning system 200 explores the state space, it may learn about the relationships between the different states. This knowledge may be used by the reinforcement learning system 200 to generate and/or update the topology of the explored state space. The topology of the explored state space is a representation of the relationships between the different states. The topology may be represented as a graph, with each state represented as a node and the edges between the nodes representing the possible transitions between states. The topology may be used to understand the structure of the state space and to plan future actions. This knowledge may be used by the reinforcement learning system 200 to solve a variety of problems, such as, but not limited to, finding the shortest path between two states, finding the best way to avoid obstacles, and playing games.

As described herein, actions attributed to an agent 202, RL system, or other system may include the agent 202 causing or otherwise interacting with some other system to perform such actions. For example, a description of an agent 202 or an RL system “performing” an action encompasses an action of agent 202 or the RL system to cause a robot or other system to perform the action. As another example, agent 202 or an RL system “obtaining” a measurement encompasses agent 202 receiving an indication of a measurement taken by a sensor of a robot or other system.

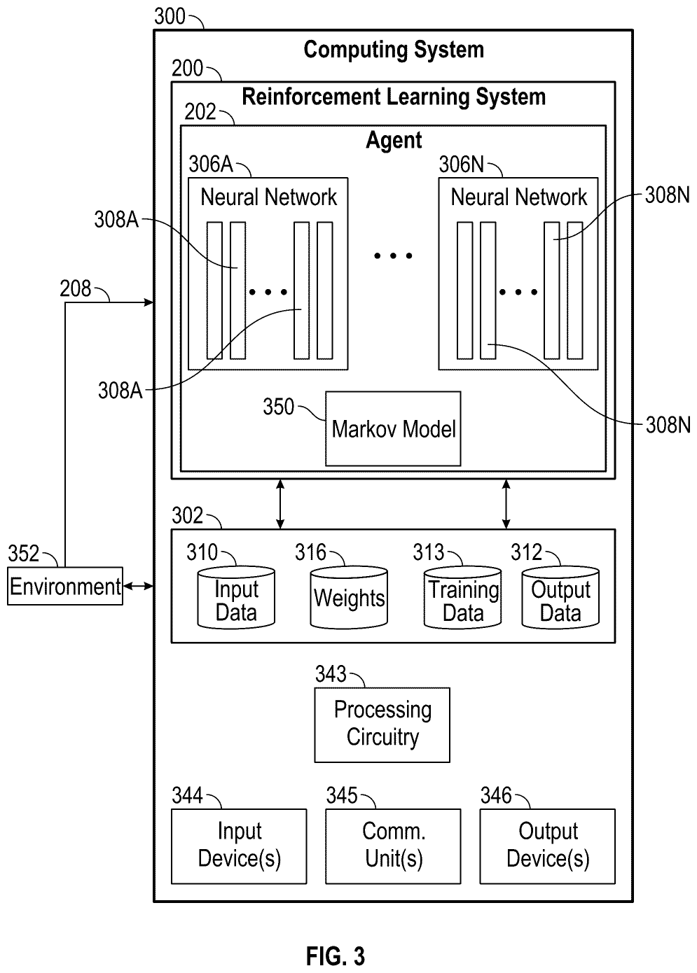

FIG. 3 is a block diagram illustrating an example computing system 300. In an aspect, computing system 200 may comprise an instance of the RL system 200. As shown, computing system 300 comprises processing circuitry 343 and memory 302 for executing a reinforcement learning system 200 having one or more neural networks 306A-306N (collectively, “NNs 306”) comprising respective sets of layers 308A-308N (collectively, “layers 308”). Each of NNs 306 may comprise various types of neural networks, such as, but not limited to, recursive neural networks (RNNs), convolutional neural networks (CNNs) and deep neural networks (DNNs). In an aspect, any of NNs 306 may comprise an example instance and implementation of the agent 202 shown in FIG. 2. However, implementations of agent 202 using machine learning models other than NNs may be used.

Computing system 300 may be implemented as any suitable computing system, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 300 may represent a cloud computing system, server farm, and/or server cluster (or portion thereof) that provides services to client devices and other devices or systems. In other examples, computing system 300 may represent or be implemented through one or more virtualized compute instances (e.g., virtual machines, containers, etc.) of a data center, cloud computing system, server farm, and/or server cluster. Computing system 300 may represent an instance of RL system 200 of FIG. 1. The reinforcement learning system 200 may further include a Markov model 350 described below.

The techniques described in this disclosure may be implemented, at least in part, in hardware, software, firmware or any combination thereof. For example, various aspects of the described techniques may be implemented within processing circuitry 343 of computing system 300, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. Processing circuitry 343 of computing system 300 may implement functionality and/or execute instructions associated with computing system 300. Computing system 300 may use processing circuitry 343 to perform operations in accordance with one or more aspects of the present disclosure using software, hardware, firmware, or a mixture of hardware, software, and firmware residing in and/or executing at computing system 300. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 300 comprises any suitable computing system having one or more computing devices, such as desktop computers, laptop computers, gaming consoles, smart televisions, handheld devices, tablets, mobile telephones, smartphones, etc. In some examples, at least a portion of system 300 is distributed across a cloud computing system, a data center, or across a network, such as the Internet, another public or private communications network, for instance, broadband, cellular, Wi-Fi, ZigBee, Bluetooth® (or other personal area network—PAN), Near-Field Communication (NFC), ultrawideband, satellite, enterprise, service provider and/or other types of communication networks, for transmitting data between computing systems, servers, and computing devices.

Memory 302 may comprise one or more storage devices. One or more components of computing system 300 (e.g., processing circuitry 343, memory 302) may be interconnected to enable inter-component communications (physically, communicatively, and/or operatively). In some examples, such connectivity may be provided by a system bus, a network connection, an inter-process communication data structure, local area network, wide area network, or any other method for communicating data. The one or more storage devices of memory 302 may be distributed among multiple devices.

Memory 302 may store information for processing during operation of computing system 300. In some examples, memory 302 comprises temporary memories, meaning that a primary purpose of the one or more storage devices of memory 302 is not long-term storage. Memory 302 may be configured for short-term storage of information as volatile memory and therefore not retain stored contents if deactivated. Examples of volatile memories include random access memories (RAM), dynamic random-access memories (DRAM), static random access memories (SRAM), and other forms of volatile memories known in the art. Memory 302, in some examples, may also include one or more computer-readable storage media. Memory 302 may be configured to store larger amounts of information than volatile memory. Memory 302 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 302 may store program instructions and/or data associated with one or more of the modules described in accordance with one or more aspects of this disclosure.

Processing circuitry 343 and memory 302 may provide an operating environment or platform for one or more modules or units of reinforcement learning system 200 (e.g., NNs 306 and Markov Model 350), which may be implemented as software, but may in some examples include any combination of hardware, firmware, and software. Processing circuitry 343 may execute instructions and the one or more storage devices, e.g., memory 302, may store instructions and/or data of one or more modules. The combination of processing circuitry 343 and memory 302 may retrieve, store, and/or execute the instructions and/or data of one or more applications, modules, or software. The processing circuitry 343 and/or memory 302 may also be operably coupled to one or more other software and/or hardware components, including, but not limited to, one or more of the components illustrated in FIG. 3.

Processing circuitry 343 may execute reinforcement learning system 200 using virtualization modules, such as a virtual machine or container executing on underlying hardware. One or more of such modules may execute as one or more services of an operating system or computing platform. Aspects of reinforcement learning system 200 may execute as one or more executable programs at an application layer of a computing platform.

One or more input devices 344 of computing system 300 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 346 may generate, transmit, or process output. Examples of output are tactile, audio, visual, and/or video output. Output devices 346 may include a display, sound card, video graphics adapter card, speaker, presence-sensitive screen, one or more USB interfaces, video and/or audio output interfaces, or any other type of device capable of generating tactile, audio, video, or other output. Output devices 346 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 300 may include a presence-sensitive display that may serve as a user interface device that operates both as one or more input devices 344 and one or more output devices 346.

One or more communication units 345 of computing system 300 may communicate with devices external to computing system 300 (or among separate computing devices of computing system 300) by transmitting and/or receiving data, and may operate, in some respects, as both an input device and an output device. In some examples, communication units 345 may communicate with other devices over a network. In other examples, communication units 345 may send and/or receive radio signals on a radio network such as a cellular radio network. Examples of communication units 345 may include a network interface card (e.g., such as an Ethernet card), an optical transceiver, a radio frequency transceiver, a GPS receiver, or any other type of device that can send and/or receive information. Other examples of communication units 345 may include Bluetooth®, GPS, 3G, 4G, and Wi-Fi® radios found in mobile devices as well as Universal Serial Bus (USB) controllers and the like.

In the example of FIG. 3, NN 306 may receive input data from an input data set 310 and may generate output data 312. Input data 310 and output data 312 may contain various types of information. For example, input data 310 may include a state signal received from the environment 352. Output data 312 may include selected actions, for example.

Each set of layers 308 may include a respective set of artificial neurons. Layers 308A for example, may include an input layer, a feature layer, an output layer, and one or more hidden layers. Layers 308 may include fully connected layers, convolutional layers, pooling layers, and/or other types of layers. In a fully connected layer, the output of each neuron of a previous layer forms an input of each neuron of the fully connected layer. In a convolutional layer, each neuron of the convolutional layer processes input from neurons associated with the neuron's receptive field. Pooling layers combine the outputs of neuron clusters at one layer into a single neuron in the next layer.

Each input of each artificial neuron in each layer of the sets of layers 308 is associated with a corresponding weight in weights 316. Various activation functions are known in the art, such as Rectified Linear Unit (ReLU), TanH, Sigmoid, and so on.

Reinforcement learning system 200 may process training data 313 to train the NN 306, in accordance with techniques described herein. For example, reinforcement learning system 200 may apply an end-to-end training method that includes processing training data 313. Reinforcement learning system 200 may process input data 310 to generate one or more selected actions as described below.

In an aspect, the reinforcement learning system 200 may select actions using the NN 306. In some aspects, the NN 306 may configured to receive an observation and to process the observation to map the observation to a next action, i.e., to a point in the continuous action space that defines an action that should be performed by the agent 202 in response to the observation. In an aspect, the next action may be chosen in a way that is likely to maximize the reward that the reinforcement learning system 200 receives. In an aspect, the next action may be selected, based at least in part on the updated topology, as described above in conjunction with FIG. 2. It should be noted that updating the topology may further comprise updating a value associated with each of the plurality of states based at least in part on the one or more measurements 208. The measurements 208 may be of any type, such as physical measurements, sensor measurements, or user input. The values associated with each state may be updated in any way that is appropriate for the specific problem.

In an aspect, a value chain associated with the topology may be a representation of the value of each state in the topology. The value of a state may be determined by a number of factors, such as, but not limited to the reward for reaching that state, the cost of reaching that state, and the probability of reaching that state. The selection of the next action may be based on the updated value chain. For example, the NN 306 may select the action that leads to the state with the highest value. In other words, the NN 306 may be more likely to select actions that lead to rewards and less likely to select actions that lead to penalties.

For example, in a robot navigation problem, the topology would be the map of the environment 352, and the states would be the locations in the environment 352. The measurements could be the robot's current position and the obstacles in the environment 352. The values associated with each state would then be updated to reflect the robot's current position and the obstacles in the environment 352.

In the context of RL, the values associated with each state are typically called Q-values. The Q-values represent the expected reward that the system will receive if it takes a particular action in a particular state. The measurements may be used to update the Q-values in a way that reflects the current state of the environment 352. For example, if NN 306 selects an action that leads to a reward, the Q-value for that state and action may be increased. This will make the NN 306 more likely to take that action in the future. Conversely, if the NN 306 selects an action that leads to a penalty, the Q-value for that state and action may be decreased. This decrease will make the NN 306 less likely to select that action in the future.

In some other implementations, the NN 306 may be configured to generate Q-values for observation-action pairs, where a Q-value for an observation-action pair represents an estimated time-discounted total future reward that the system will receive if the agent 202 performs the action in response to the observation in the pair. Given an observation, the NN 306 may select an action that yields the highest possible Q-value. In some aspects, the NN 306 may select an action to be performed by the agent 202 in response an observation by using an action selection policy 204 (exploration policy). For example, when the set of possible actions to be performed by the agent is discrete, the NN 306 may use an epsilon-greedy policy. In some other implementations, the NN 306 may select actions according to a probability distribution over possible actions.

In an aspect, the computing system 300 may be used to find a diverse set of solutions to a problem. The computing system 300 may first use the reinforcement learning system 200 to train the Markov model 350. The Markov model 350 may be a probabilistic model that may be used to predict the next state of a system given the current state. Once the Markov model 350 is trained, the computing system 300 may use the Markov model 350 to perform optimization in the latent space.

In an aspect, the environment 352 may be the world that the agent 202 interacts with. In an aspect, the environment 352 may comprise an instance of the environment 206 shown in FIG. 2. The environment 352 may be configured to provide the NN 306 with information about the state of the world, and to generate rewards and punishments. The environment 352 may be anything from a physical environment, such as a room, to a simulated environment, such as a game. In an aspect, the environment 352 may be represented as a set of states, actions, and transitions. States are the different situations that the agent 202 can be in. Actions are the things that the agent can perform. Transitions are the changes that can happen in the environment 352, such as the agent moving from one state to another.

The environment 352 may also be responsible for generating rewards and punishments. Rewards are given to the agent 202 for taking actions that lead to desirable outcomes. Punishments are given to the agent 202 for taking actions that lead to undesirable outcomes.

As noted above, RL is a type of machine learning that allows agents 202 to learn how to behave in the environment 352 by trial and error. The agent 202 may learn by receiving rewards for taking actions that lead to desired outcomes. The temporal difference (TD) update rule is a common update rule used in RL. The TD update rule is based on the Bellman equation, which is an equation that describes the relationship between the value function and the optimal policy. The Bellman equation states that the value function of a state is equal to the expected value of the reward received in that state plus the value function of the next state. The discount factor, y, is a number between 0 and 1 that represents how much the agent 202 values future rewards. The policy 204 is fixed, which means that the agent 202 will always take the same action in each state. In other words, the expected reward may be calculated by simply multiplying the reward matrix by the policy matrix and the discount matrix. The TD update rule approximates the Bellman equation by updating the value function estimate based on the reward received in the current state and the value function estimate of the next state. The function h(s) is a value function estimate.

An MDP is a type of stochastic control problem. An MDP is a mathematical model of a decision-making process in which the state of the system evolves over time according to a Markov chain, and the decision-maker chooses actions in order to maximize some expected reward. The Bellman equations are a set of recursive equations that may be used to compute the value function of an MDP. In an aspect, the reinforcement learning system 200 may be based on Markov decision processes (MDPs) because MDPs provide a mathematical framework for modeling sequential decision-making problems. An MDP may be defined by four components: state space, action space, transition function and a reward function. In an aspect, the state space may include the set of all possible states that the agent 202 may be in. In an aspect, the action space may include the set of all possible actions that the agent 202 may take. In an aspect, the transition function may be a function that maps from a state and an action to the probability of transitioning to a new state. In an aspect, the reward function may be a function that maps from a state and an action to a reward that the agent 202 receives for taking that action in that state.

TD learning is a reinforcement learning algorithm that updates a value function estimate based on the difference between the estimated value of the current state and the actual reward received in that state. The TD update rule may be defined as follows:

V(s)←V(s)+a(r+γV(s′)−V(s)),

where V(s) is the value function estimate for state s,
r is the reward received in state s,
γ is a discount factor that determines how much weight is given to future rewards,
V(s′) is the value function estimate for the next state, s′,
α is a learning rate that controls how much the value function estimate is updated.
The TD update rule may be seen as an approximation of the Bellman equation, which is a fundamental equation in reinforcement learning. The Bellman equation states that the value function of a state is equal to the expected value of the reward received in that state plus the value function of the next state. The TD update rule may approximate the Bellman equation by using the actual reward received in the current state instead of the expected value of the reward.

Discounting is a technique that may be used by the reinforcement learning system 200 to reduce the importance of future rewards. Discounting may be done by multiplying the rewards by a discount factor, γ, which may be a number between 0 and 1.

Potential theory is a branch of mathematics that deals with the study of functions that satisfy certain differential equations. The theory of Markov chains deals with the study of stochastic processes. A stochastic process is a process that involves randomness. In an aspect, there is a close relationship between the theory of Markov chains and potential theory.

In an aspect, the computing system 300 may implement a special case of reinforcement learning (referred to as Dirichlet Differencing±DD) where rewards are confined to a “boundary.” In other words, the agent 202 may only receive rewards in certain states, and not in others. This type of RL is known as an absorbing Markov chain. In an aspect, the Markov Model 350 may comprise an instance of the absorbing Markov chain.

In the general case of distributed rewards, the agent 202 may receive rewards in any state, not just in absorbing states. This type of RL is more general than absorbing Markov chains, and it is more challenging to solve.

The traditional update rule, referred to herein as TD learning, updates the value function estimate based on the difference between the estimated value of the current state and the actual reward received in that state. The TD update rule is applied to the most recent sample, which is a sequence of states that the agent 202 has visited. The various aspects of the techniques described in this disclosure implement the alternative update rule, referred to herein as DD learning, which updates the value function estimate of all previously-explored states. DD uses a relaxation approach to distribute credit, which is analogous to solutions for electrical potentials. Accordingly, DD may offer orders-of-magnitude improvement in running times, and far fewer samples to attain smooth, accurate value functions.

Relaxation update is a method of distributing credit across multiple states or actions in the state space. In an aspect, relaxation update may be implemented by gradually decreasing the weight of the reward as the distance from the state or action that directly received the reward increases. Relaxation update may help to ensure that all actions that played a role in achieving the reward are given some credit.

In an aspect, in the first case, where the value function is a harmonic function, the metrics may be used to assess the quality of the agent's internal model. A good internal model may produce a value function that is close to the true value function. In the second case, where the value function is a Poisson function, the metrics may be used to compare the agent's learned value function with the theoretical value function. The theoretical value function may be calculated if the reward function and the state space are known. Furthermore. in the second case the so-called “bake-off” needs to compare agent learned value functions with theoretical “full-model” metrics. A bake-off is a comparison of different algorithms or approaches. In this case, the bake-off would compare different RL algorithms to see which one performs best.

As noted above, potential theory is a branch of mathematics that deals with the study of functions that satisfy certain differential equations. Such functions are called potential functions. In an aspect, the potential theory may be used to impose strong formal constraints on value functions in RL. These constraints may be used to derive measurements that may be used to assess the quality of value function estimates for absorbing MDPs. Absorbing MDPs are a type of MDP where the agent may only enter a finite set of absorbing states. Once the agent enters an absorbing state, it cannot leave. Accordingly, solution methods for problems in potential theory may be used to derive the alternative update rule for RL-DD. This alternative update rule has been shown to converge much faster than traditional TD and to produce value functions that are much closer to their theoretical limits.

The Markov model 350 may model the evolution of a system over time. Classical potentials are functions that describe the potential energy of a system. Probability theory identifies Markov chain outcome probabilities with classical potentials. In other words, the probability of transitioning from one state to another in the Markov model 350 may be related to the potential energy of the system. Classical potentials describe physical phenomena like electrical potential in a resistive network, ideal fluid flow, steady-state temperature in a medium, equilibrium concentration in diffusion, and others. In other words, the concepts of classical potentials may be applied to a wide variety of problems.

In an aspect, the Markov model 350 may describe the evolution of a system over time. The system may be in any one of a finite or infinite number of states. The transition matrix, P, is a square matrix that describes the probability of any random process (e.g., the agent 202) transitioning from one state to another. The entry Pᵢⱼ of the transition matrix is the probability that a random process in state sᵢ makes a transition to state sⱼ. The transition matrix is stochastic if each of its rows sums to 1. In other words, the sum of the probabilities of transitioning from any state to all other states is 1.

With respect to absorbing Markov chains, once the process enters an absorbing state, it cannot leave. The set Sₐ is called the absorbing set because once the process enters a state in Sₐ, it is absorbed into that state and cannot move to any other state. Processes on finite absorbing Markov chains may always terminate eventually, while processes on non-absorbing chains never terminate because in a finite absorbing Markov chain, there are only a finite number of states, and the process should eventually enter an absorbing state. In an aspect. the Markov model 350 may comprise a finite, time-homogeneous absorbing Markov chain governed by a stochastic transition matrix P.

An eigenvector of a matrix is a vector that is multiplied by the matrix to give a scalar multiple of itself. The eigenvector corresponding to the eigenvalue 1 is called the principal eigenvector. In the case of a transition matrix, the left eigenvector corresponding to the eigenvalue 1 is called the stationary distribution of the Markov chain. The stationary distribution is the distribution of states that the Markov chain will eventually reach if it is allowed to run for a long time. The stationary distribution is important in inference problems because the stationary distribution may be used to find the most likely state of the Markov chain given the observed data. In the case of an absorbing Markov chain, the stationary distribution is concentrated at the absorbing set.

As noted above, a hitting probability is the probability that a Markov chain will reach a particular state before it reaches any other state. In the case of an absorbing Markov chain, the hitting probability is the probability that the Markov chain will reach an absorbing state before it reaches any non-absorbing state. The right eigenvector of a transition matrix corresponding to the eigenvalue 0 is called the hitting probability of the chain. The hitting probability is a vector that contains the hitting probabilities for all states in the Markov chain. If the chain is non-absorbing, then the hitting probability is trivial since the process is never absorbed. In other words, all hitting probabilities for a non-absorbing chain are zero. For absorbing chains, however, the hitting probability may be used to predict the future behavior of the process.

For example, in a robot path planning problem, the goal is to find a path from a start state to a goal state. The path should avoid obstacles. The set Sa of absorbing states can be partitioned into two sets: the goal states, G, and the obstacle states, O. The hitting probability may be used to find the probability that the robot will reach the goal states before it hits any obstacle states.

The Laplace operator is a differential operator that may be used to find the second derivative of a function. The Laplace equation is an equation that states that the sum of the second derivatives of a function is zero and may be represented as:

$${\sum }_{i} \frac{{\partial }^{2} h}{\partial {x}_{i}^{2}} = 0$$

In the context of Markov chain theory, the Laplace operator may be used to find the hitting probability of a Markov chain. The hitting probability is the probability that a Markov chain will reach a particular state before it reaches any other state.

The Bellman equation is a recursive equation that is used to find the optimal value function for an MDP.

Two properties of harmonic functions that are useful in an RL context are discussed next. The first property is that harmonic functions only achieve extrema at the boundary of that neighborhood. In other words, harmonic functions cannot have a maximum or minimum value within the neighborhood. The second property is that the harmonic function's mean value on the neighborhood is found only in the interior of that neighborhood. In other words, the average value of the function within the neighborhood is equal to the value of the function at a point in the interior of the neighborhood. The first property is called the min-max property. The min-max property is useful in RL because it guarantees that the value function cannot have a local minimum within the domain.

A boundary value problem is a problem that specifies the values of a function on the boundary of a domain. The problem is to find the function that satisfies the given boundary conditions and also satisfies a differential equation within the domain. The Laplace equation is a boundary value problem because it specifies the values of the function on the boundary of the domain. The boundary conditions in the Laplace equation are called Dirichlet boundary conditions. In the context of Markov chains, the absorbing states can be thought of as the boundary of the domain. The probabilities that are assigned to the absorbing states are the boundary conditions. In an aspect, the reinforcement learning system 200 may be configured to find the value function that satisfies the given boundary conditions and also satisfies the Bellman equation within the domain.

In the context of machine learning, quality and residuals are two measurements used to evaluate the performance of a model. Quality measures how well the model predicts the actual values. Residuals are the difference between the predicted values and the actual values.

A value function is a function that maps each state to its expected value. The expected value is the sum of the rewards that the agent 202 can expect to receive from that state, discounted by the probability of receiving each reward. In an absorbing Markov chain, a value function that has local minima or maxima is flawed because the agent 202 will get stuck in the local minimum or maximum state and will not be able to reach the absorbing states. The quality metric is a measure of how flawed a value function is.

A residual is the difference between the current estimate of the value function and the theoretical limit of the value function. The theoretical limit of the value function is the eigenvector of the transition operator corresponding to the eigenvalue 0. The residuals may be used to measure the convergence of the value function estimation process.

Poor convergence and poor quality are each indicators that control will fail or exhibit poor performance because if the value function is not accurate, then the agent 202 will not be able to make good decisions about which actions to take. The quality metric and residuals metric can be used by the reinforcement learning system 200 to evaluate the suitability of a value function for control. There are a number of different metrics that may be used to generate a quality of a value function estimate for an absorbing MDP. Such metrics may include, but are not limited to, Mean Squared Error (MSE), Root Mean Squared Error (RMSE), relative error, maximum error, and the like. The choice of which metric to use may depend on the specific problem that is being solved. For example, if the goal is to minimize the error between the estimated value function and the true value function, then the MSE or RMSE might be a good choice. If the goal is to minimize the relative error, then the relative error might be a good choice. If the goal is to minimize the maximum error, then the maximum error might be a good choice.

To illustrate the effectiveness of DD, different reinforcement learning algorithms are compared below. IncrementalChain algorithm is a model-free algorithm that learns the value function incrementally. The IncrementalChain algorithm may maintain a record of the states that it has explored and the rewards that it has received in those states. The IncrementalChain algorithm then uses this information to update the value function. DD is a model-based algorithm that learns the value function using dynamic programming.

TD agents learn the value function incrementally, using a process called temporal difference learning. Temporal difference learning updates the value function based on the difference between the expected reward and the actual reward. DD agents learn the value function using dynamic programming. Dynamic programming may construct a table that stores the value of each state.

An absorbing state is a state in which the agent cannot move to any other state. When the agent 202 receives a reward at an absorbing state, the agent 202 may distribute the credit for the reward over all the states that led to the absorbing state.

As noted above, a DD agent is a model-based reinforcement learning agent that may be configured to estimate a value function using a Dirichlet Differencing (DD) update rule using dynamic programming. Dynamic programming constructs a table that stores the value of each state. The agent 202 then uses this table to find the optimal policy. When a DD agent receives a reward at an absorbing state, the DD agent may perform an update only at that rewarding state because the DD agent knows the topology of the state space, so the DD agent knows which states are connected to the absorbing state. The DD agent treats the reward as a reward prediction error (RPE).

It should be noted that disclosed techniques may be applied to a non-absorbing Markov chain case as well. In potential-theoretic terms, the non-absorbing case corresponds to Poisson's Equation, which may be represented as:

∇²h=f

where f is a function of state and is called the “source” or “load” function. In RL terms, f is a distributed reward function. A relaxation computation similar to the DD case described above may be applicable to the non-absorbing case. The Poisson agent does not assume absorption but may update its value function wherever nonzero reward is available. The Poisson agent may internally maintain 3 learned features: 1) the value function, 2) the transition count operator, and 3) an averaged reward function. All of these features may be incremental and may be extended only as new states are encountered by the Poisson agent through transition.

The main computational difference between the absorbing and non-absorbing Markov chain cases is that the relaxation update in the non-absorbing case may be performed at every encountered state that has nonzero reward, rather than only at the absorbing set of states. Although such relaxation update may seem to be computationally expensive, the disclosed technique may radically improve convergence rates, resulting in a value function with fewer defects than the TD-based computation. The case of distributed rewards is applicable to continuous control problems that run indefinitely.

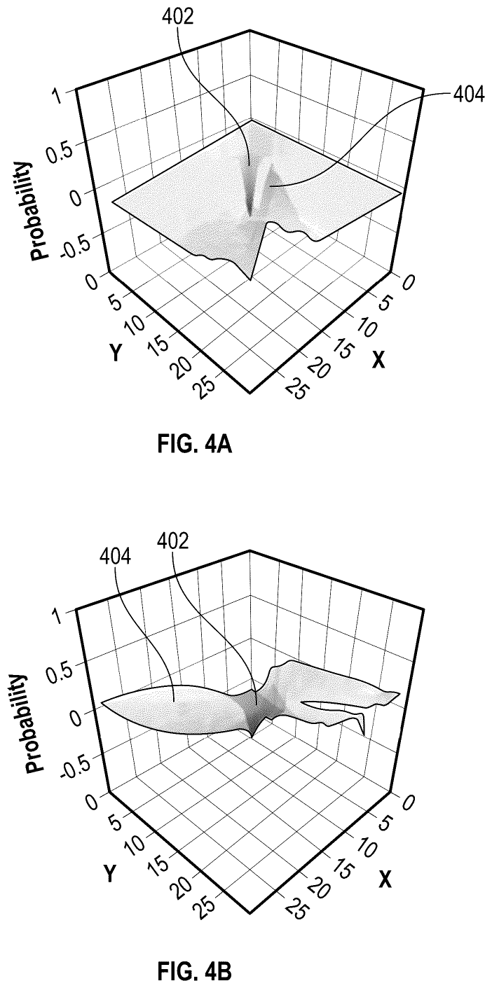

FIGS. 4A and 4B are graphs depicting world transitions as learned via different versions of reinforcement learning (RL) agents in accordance with the techniques of the disclosure. Both a TD agent 404 and DD agent 402 are depicted in FIG. 4A. The world object in this example is a 30×30 2D grid, and two states (s_start and s_end) comprise the absorbing set. The agent may sample this world using the simulate agent method to build up estimates for the value function. The DD agent 402 learns the value function and transition operator in this case.

The TD agent 404 may require more than 200 seconds to converge to a function with modest quality (0.8) and poor residual (between 3 and 4) because the TD agent 404 is a stochastic algorithm, and the results may vary depending on the random sequence of states that the agent explores. The DD agent 402, on the other hand, may converge to a function with high quality (0.99) and low residual (near 0) in approximately 20-30 seconds because the DD agent 402 is a deterministic algorithm, and the results are not affected by the random sequence of states that the DD agent 402 explores. The DD value function estimate is also much smoother than the TD value function estimate because the DD agent 402 uses the transition probabilities between states to learn the value function, while the TD agent 404 only uses the rewards that it receives. The DD value function also has a useful gradient everywhere within the observed state space.

Evaluation surveys were performed to compare the behavior of the TD agent 404 and the DD agent 402 over various domains: trees, grids, and general undirected graphs. The survey results suggested that the average graph degree had a critical effect on performance. In other words, the number of edges connected to each node in the graph had a significant impact on how well the agents performed. In all cases, the agents were started with a “blank slate”, which means that they had no prior knowledge of the environment 352. The agents were also limited to querying the world for the “reachable” neighbors of their current state. In other words, the agents could only learn about the environment 352 by exploring it. The survey results showed that the DD agent 402 outperformed the TD agent 404 in all domains. However, the degree of improvement was dependent on the average graph degree. In domains with low average graph degree, the DD agent 402 had a small advantage over the TD agent 404. However, in domains with high average graph degree, the DD agent 402 had a much larger advantage over the TD agent 404. The reason for this difference in performance is that the DD agent 402 is able to learn the transition probabilities between states more accurately than the TD agent 404 because the DD agent 402 uses the entire state space to learn the transition probabilities, while the TD agent 404 only uses the states that it has visited in a sample. In domains with low average graph degree, the state space is small, so the TD agent 404 is able to learn the transition probabilities accurately. However, in domains with high average graph degree, the state space is large, so the TD agent 404 is not able to learn the transition probabilities as accurately.

In an aspect, the TD agent 404 and the DD agent 402 may be compared using three measurements: running time, residual, and quality. Running time is the time it takes for the agent to learn the value function. Residual is the difference between the estimated value function and the theoretical limit of the value function. Quality is a measure of how well the estimated value function approximates the true value function. Both kinds of agents 402, 404 may randomly explore the environment to build up the value function. In other words, the agents 402, 404 do not have any prior knowledge of the environment 352. The agents 402 and 404 learn about the environment 352 by exploring it and receiving rewards or penalties. For comparison, reward and penalty occur only at two states in the world. In other words, the agents 402, 404 may only be motivated to explore these two states. Both kinds of agents 402, 404 may be compared with respect to the same reward function. In other words, the agents 402, 404 may be evaluated on their ability to maximize the expected reward. The three measurements may be used to compare the performance of the TD agent 404 and the DD agent 402. The TD agent 404 is typically faster than the DD agent 402, but the DD agent 402 is typically more accurate. The quality metric may be used to determine which agent is more accurate. The residual metric may be used to determine how close the estimated value function is to the theoretical limit. The choice of agent may depend on the specific application. If speed is critical, then the TD agent 404 may be a better choice. If accuracy is critical, then the DD agent 402 may be a better choice.

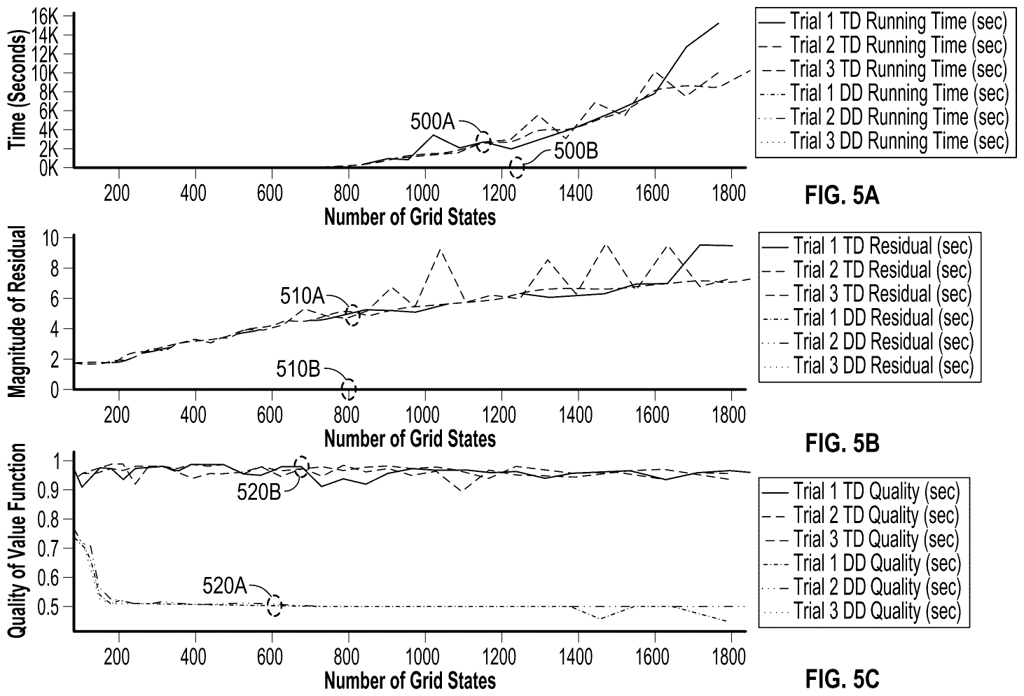

FIGS. 5A-5C are graphs depicting different measurements for different versions of RL agents (e.g., TD agent 404 and DD agent 402 in these examples) exploring different two-dimensional world graphs in accordance with the techniques of the disclosure. In this example, the agents 402, 404 were tasked to explore worlds that are 2D grids, ranging in size from 10×10 nodes to 50×50 nodes. The agents 402, 404 were tasked with learning value functions for this environment with a minimum quality value of 0.5. The results of the timing trial are shown in FIG. 5A. The DD agent 402 is much faster than the TD agent 404 for large worlds. The reason for this difference in speed is that the DD agent 402 is able to learn the value function more efficiently than the TD agent 404 because the DD agent 402 uses the entire state space to learn the value function, while the TD agent 404 only uses the states that it has visited. The quality level of 0.5 means that only half the state space is “usable” for control because the value function is only accurate in states with a quality of 0.5 or higher. The results of the timing trial suggest that the DD agent 402 is a better choice for applications where the state space is large or complex because the DD agent 402 is faster and more accurate than the TD agent 404. The quality level of 0.5 was chosen in this example because this level is a reasonable compromise between accuracy and speed. The results of the timing trial may not be generalizable to other environments. The choice of agent may depend on the specific application. If speed is critical, then the DD agent may be a better choice. If accuracy is critical, then the DD agent may also be a better choice, but the difference in accuracy may not be significant.

Still referring to FIG. 5A, the plot shows the running time of the TD and DD agents for different sizes of 2D grids. The running time of the TD agent grows quadratically 500A with the size of the grid , while the running time of the DD agent grows linearly 500B with the size of the grid because the TD agent 404 has to explore the entire state space to learn the value function, while the DD agent 402 only has to explore the reachable states. The next plot shown in the example of FIG. 5B illustrates the residual of the value function for the TD agent 404 and the DD agent 402 for different sizes of 2D grids. The residual is the difference between the estimated value function and the theoretical limit of the value function. The residual of the TD agent 510A is much higher than the residual of the DD agent 510B because the TD agent 404 is not able to learn the value function as accurately as the DD agent 402. As shown in FIGS. 5A and 5B, the DD agent 402 is dramatically faster than the TD agent 404 for large worlds because the DD agent 402 is able to learn the value function more efficiently than the TD agent 404. The DD agent is also able to learn the value function more accurately than the TD agent.

The plot in FIG. 5C shows the quality of the value function for the TD and DD agents for different sizes of 2D grids. The quality is a measure of how well the estimated value function approximates the true value function. The quality of the TD agent 520A stays near 0.5 for larger grids, while the quality of the DD agent 520B exhibits values greater than 0.9 because the DD agent 402 is able to learn the value function more accurately than the TD agent 404. The DD agent's 402 value functions may better maintain the min-max property over most of the state space. In other words, the DD agent's 402 value functions are more likely to be accurate in all states, not just in states that are visited frequently. The results of the quality plot suggest that the DD agent 402 is a better choice for applications where accuracy is critical because the DD agent 402 is able to learn the value function more accurately than the TD agent 404. The results of the timing trial, the residual plot and the quality plot may be used to help choose the best agent for a specific application.

In summary, the traditional approach to update the value function in reinforcement learning is to update the value function using a state trace restricted to the most recent sample (walk). Such approach is a linear chain of states. The “credit” for the reward is distributed exponentially across the chain. In an aspect, the techniques described in this disclosure update the values of all previously-explored (learned) states using discovered state connectivity, not just along the sample path, but across all previously explored states. The “credit” may be distributed using a relaxation approach analogous to solutions for electrical potentials. Furthermore, the techniques described in the disclosure offer orders-of-magnitude improvement in running times, and far fewer samples to attain smooth, accurate value functions. The traditional approach is a simple and efficient way to update the value function. However, the traditional approach may be inaccurate in some cases, especially when the state space is large or complex. The techniques described in the disclosure are more complex and computationally expensive, but these techniques may be more accurate than the traditional approach because the techniques described herein take into account the entire state space, not just the most recent sample.

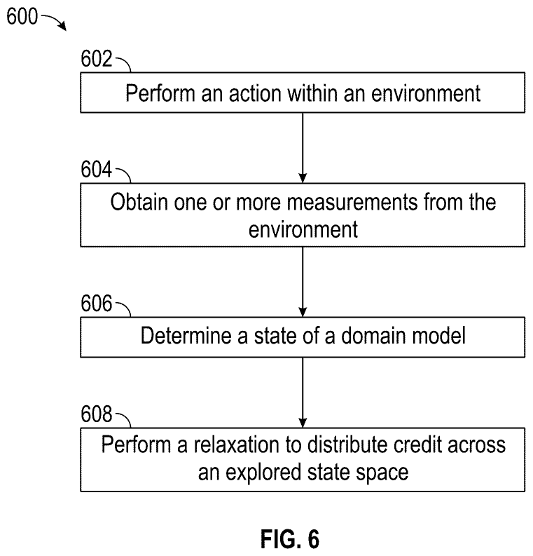

FIG. 6 is a flowchart illustrating an example mode of operation for a machine learning system, according to techniques described in this disclosure. Although described with respect to computing system 300 of FIG. 3 having processing circuitry 343 that executes reinforcement learning system 200, mode of operation 300 may be performed by a computation system with respect to other examples of machine learning systems described herein.

In mode of operation 600, processing circuitry 343 executes reinforcement learning system 200. Reinforcement learning system 200 may perform an action within an environment (602). Reinforcement learning system 200 may obtain one or more measurements from the environment (604). The one or more measurements may be resultant of the action. Reinforcement learning system 200 may next determine, based on the one or more measurements, a state of a domain model for the environment reached by the agent (606). In an aspect, when a DD agent receives a reward at an absorbing state, the DD agent may perform an update only at that rewarding state because the DD agent knows the topology of the state space, so the DD agent knows which states are connected to the absorbing state. Next, reinforcement learning system 200 may perform a relaxation to distribute credit, based at least in part on a reward associated with the state, across an explored state space for the domain model for the environment (608).

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), analog circuits or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A system comprising:
processing circuitry in communication with storage media, the processing circuitry configured to execute a reinforcement learning system configured to:
perform, by an agent, an action within an environment;
obtain one or more measurements from the environment, the one or more measurements resultant of the action performed by the agent;
determine, based on the one or more measurements, a state of a domain model for the environment reached by the agent; and
distribute credit, based at least in part on a reward associated with the state, across an explored state space for the domain model for the environment.

2. The system of claim 1, wherein the reinforcement learning system comprises an absorbing Markov chain comprising a harmonic function of the Markov chain.

3. The system of claim 2, wherein the absorbing Markov chain comprises a time-homogeneous Markov chain governed by a stochastic transition matrix P.

4. The system of claim 2, wherein a stationary distribution for the absorbing Markov chain is concentrated at one or more absorbing states and is 0 at other states.

5. The system of claim 1, wherein the reinforcement learning system is configured to implement one or more Markov decision processes (MDPs) represented using a state space, an action space, a transition function, and a reward function.

6. The system of claim 5, wherein the reinforcement learning system is further configured to estimate a value function using a Dirichlet Differencing (DD) update rule.

7. The system of claim 1, wherein the reinforcement learning system is further configured to estimate a value function and wherein one or more measurements indicate a quality of the estimated value function.

8. The system of claim 7,
wherein the one or more measurements indicate a quality of the estimated value function for the one or more MDPs, and
wherein the one or more MDPs comprise an absorbing MDP.

9. The system of claim 1, wherein a reinforcement learning system is further configured to:
perform a plurality of actions within the environment to explore the state space for the domain model; and
generate a topology of the explored state space.

10. The system of claim 1, wherein the reinforcement learning system configured to distribute the credit across the explored state space is further configured to perform a relaxation update to distribute the credit.

11. The system of claim 10, wherein the reinforcement learning system comprises a non-absorbing Markov chain.

12. The system of claim 11, wherein the relaxation update is performed at every encountered state that has nonzero reward.

13. A method comprising:
performing, by an agent, an action within an environment;
obtaining, by a reinforcement learning system, one or more measurements from the environment, the one or more measurements resultant of the action performed by the agent;
determining, by the reinforcement learning system, based on the one or more measurements, a state of a domain model for the environment reached by the agent; and
distributing credit, by the reinforcement learning system, based at least in part on a reward associated with the state, across an explored state space for the domain model for the environment.

14. The method of claim 13, wherein the reinforcement learning system comprises an absorbing Markov chain comprising a harmonic function of the Markov chain.

15. The method of claim 14, wherein the absorbing Markov chain comprises a time-homogeneous Markov chain governed by a stochastic transition matrix P.

16. The method of claim 14, wherein a stationary distribution for the absorbing Markov chain is concentrated at one or more absorbing states and is 0 at other states.

17. The method of claim 13, wherein the reinforcement learning system is configured to implement one or more Markov decision processes (MDPs) represented using a state space, an action space, a transition function, and a reward function.

18. The method of claim 17, wherein the reinforcement learning system is further configured to estimate a value function using a Dirichlet Differencing (DD) update rule.

19. The method of claim 13, wherein the reinforcement learning system is configured to estimate a value function and wherein one or more measurements indicate a quality of the estimated value function.

20. Non-transitory computer-readable storage media having instructions encoded thereon, the instructions configured to cause processing circuitry to:
perform, by an agent, an action within an environment;
obtain one or more measurements from the environment, the one or more measurements resultant of the action performed by the agent;
determine, based on the one or more measurements, a state of a domain model for the environment reached by the agent; and
distribute credit, based at least in part on a reward associated with the state, across an explored state space for the domain model for the environment.
